(19) United States
(12) Patent Application Publication
(10) Pub. No.: US 2014/0113719 A1
(43) Pub. Date: Apr. 24, 2014

(54) COMPUTING DEVICE AND VIDEO GAME DIRECTION METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/024,632

(22) Filed: Sep. 12, 2013

(30) Foreign Application Priority Data
Oct. 23, 2012 (TW) 101138992

(51) Int. Cl. A63F 13/04

(52) U.S. Cl. CPC A63F 13/04
USPC 463/31

(57) ABSTRACT

A computing device includes a video game direction system. The system sets correct action samples and wrong action samples for a video game and a standard for determining whether actions of players are correct. When a player starts the video game in the computing device, the system displays the correct action samples on a screen, receives movement data in relation to each action of the player, compares the movement data in relation to each action of the player with movement data of a corresponding correct action sample, and determines whether the action performed by the player is correct according to a comparison result and the standard. If the action is correct, the system displays a next correct action sample on the screen. Otherwise, if the action is wrong, the system determines which wrong action sample that the action belongs to, and displays suggestions to correct the action on the screen.

### BACKGROUND

1. Technical Field

Embodiments of the present disclosure relate to action direction systems and methods, and more particularly to a computing device and a computer game direction method.

2. Description of Related Art

Video games allow people to simulate physical sports with assistance of images displayed on screens of electronic devices (e.g., computers, TVs, smart phones). Break through operations of inputs by handles, a player inputs the operations via physical actions. Often, the player does not need to mimic exact actions when playing such a video game, so the player may gain less fitness, or even form bad exercise gestures.

### BRIEF DESCRIPTION OF THE DRAWINGS

FIG. 1 is a block diagram of one embodiment of a computing device including a video game direction system.

FIG. 2 is a block diagram of one embodiment of a video game direction method.

FIG. 3A and FIG. 3B illustrate user interfaces provided by the video game direction system shown in FIG. 1.

FIG. 4 illustrates an example of creating action samples for the video game direction system shown in FIG. 1.

FIG. 5 illustrates X, Y, Z coordinate data in relation to body parts (e.g., the head, arms, legs) of a player, which are detected by detection devices worn on the player.

FIG. 6 illustrates X, Y, Z coordinate data in relation to the body parts of the player, which are detected by the detection devices worn on the player.

FIG. 7 lists examples of wrong action samples.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

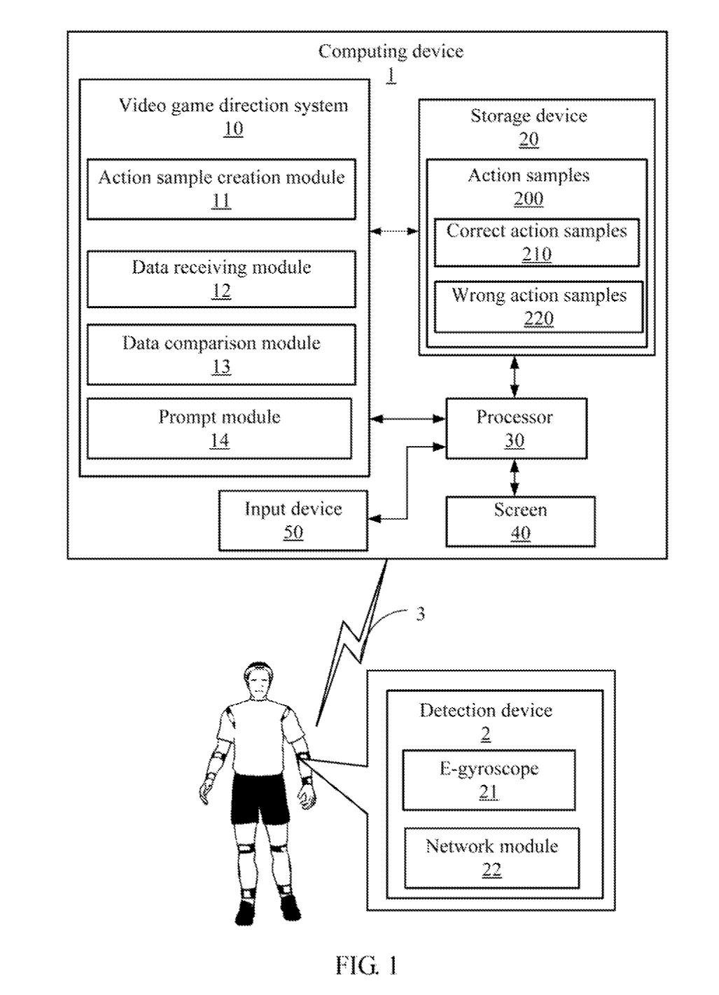

FIG. 1 is a block diagram of one embodiment of a computing device 1. The computing device 1 includes a video game direction system 10 (hereinafter, the system 10), a storage device 20, a processor 30, a screen 40, and an input device 50. The storage device 20 stores one or more video games and a plurality of action samples 200 of the video games. The action samples 200 include correct action samples 210 and wrong action samples 220. The correct action samples 210 of each video game are demonstration actions which can be displayed on the screen 40, so that players can imitate the demonstration actions to play the video game.

As shown in FIG. 1, a player wears one or more detection devices 2 on his/her body parts, such as the head, arms, legs, for example. Each detection device 2 includes an electronic gyroscope (E-gyroscope) 21 and a network module 22. When the player starts a video game stored in the storage device 20, the system 10 reads the correct action samples 210 of the video game, and displays the correct action samples 210 on the screen 40. The E-gyroscope 21 of the one or more detection devices 2 detects movements of the player when the player does actions, and the network module 22 transmits data of the movements (movement data) to the computing device 1. The system 10 determines whether the actions of the player are correct by comparing the movement data with data of the correct action samples 210, and displays a determination result on the screen 40. If the actions of the player are not correct, the system 10 further displays reasons about why the actions are not correct and recommends suggestions via the screen 40, to help the player to correct his/her actions.

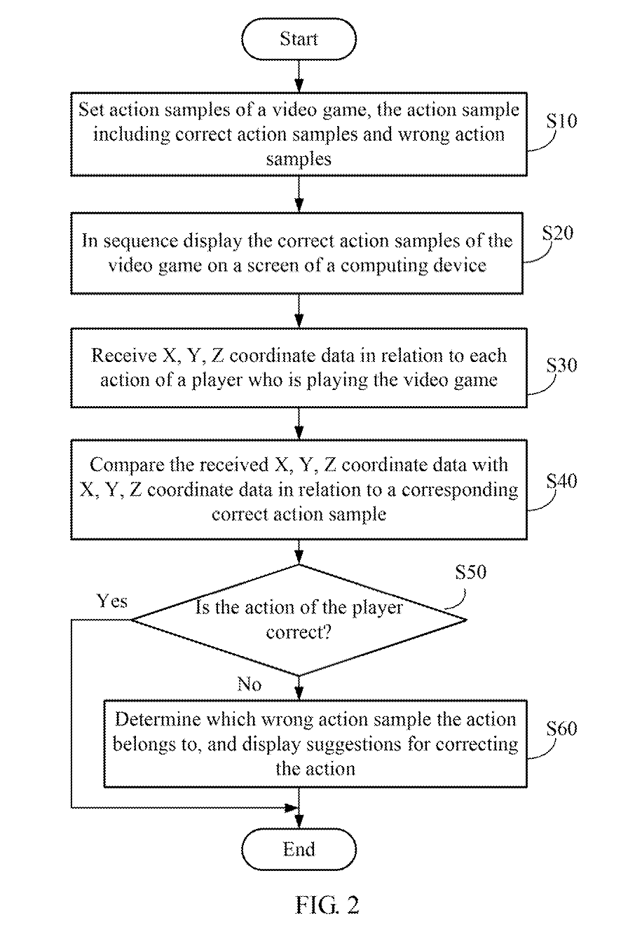

As shown in FIG. 1, the system 10 includes a plurality of function modules, such as an action sample creation module 11, a data receiving module 12, a data comparison module 13, and a prompt module 14. The modules 11-14 include computerized code in the form of one or more programs, which are stored in the storage device 20 of the computing device 1. The processor 30 executes instructions of the one or more programs, to provide the aforementioned functions of the system 10. Detailed functions of the modules 11-14 are given in reference to FIG. 2-FIG. 7.

FIG. 2 is a block diagram of one embodiment of a video game direction method. Depending on the embodiment, additional steps may be added, others removed, and the ordering of the steps may be changed.

Step S10, the action sample creation module 11 sets the action samples 200 for a video game (e.g., a baseball game) and a standard for determining whether actions of players are correct when playing the video game. The standard may be a degree of similarity between each action of player and a correct action sample 210 being equal to or more than a predetermined value (e.g., 80%).

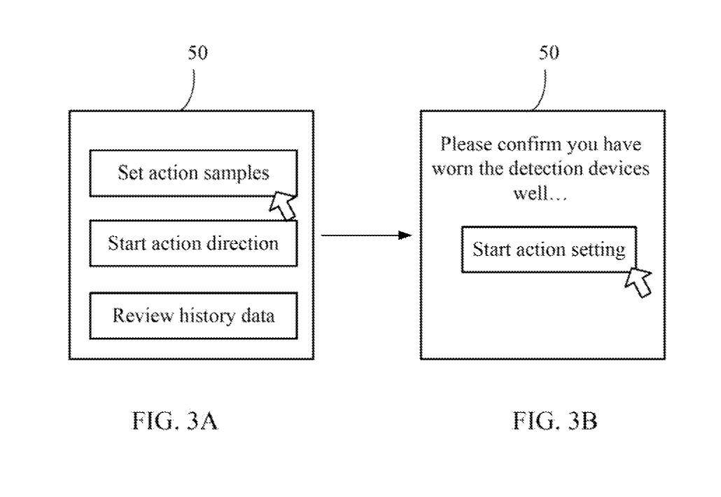

The action samples 200 (including the correct action samples 210 and wrong action samples 220) are obtained as follows: a user (e.g., an engineer or a professional player or athlete) wears one or more detection devices 2 on his/her body parts, such as the head, the arms, the legs. As shown in FIG. 3A, the system 10 provides a user interface on the screen 40. The user interface displays a plurality of options, such as an option “Set action samples,” “Start action direction,” and “Review history data.” When the user selects the option “Set action samples,” the system 10 displays prompts such as “Please confirm you have worn the detection devices correctly . . . ” and an option “Start action setting,” as shown in FIG. 3B. After the user has put on the one or more detection devices 2 correctly and selects the option “Start action setting” shown in FIG. 3B, the user begins to demonstrate the action samples 200 (the correct action samples 210 or the wrong action samples 220).

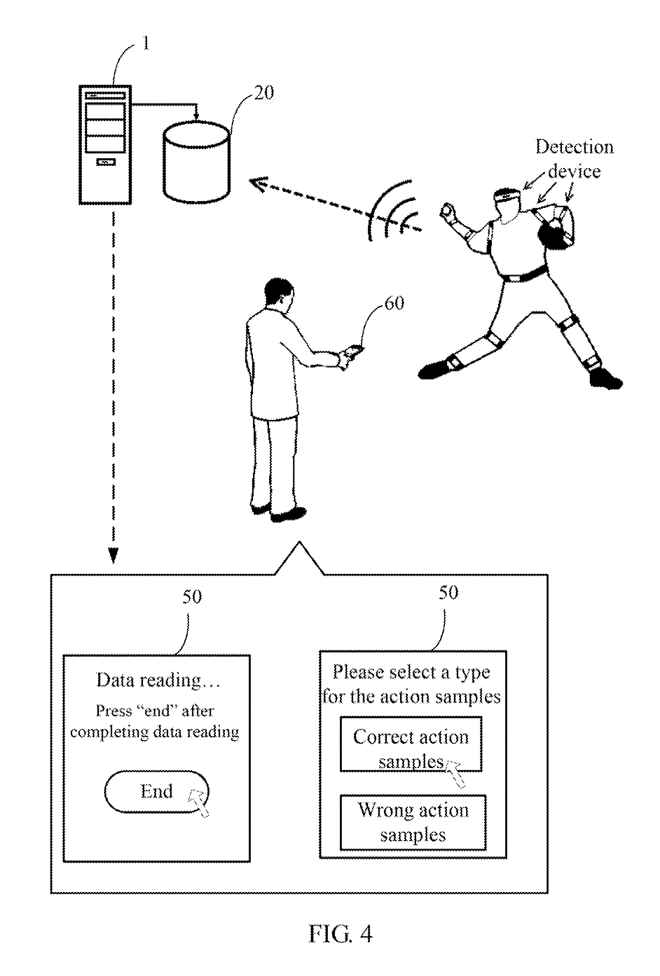

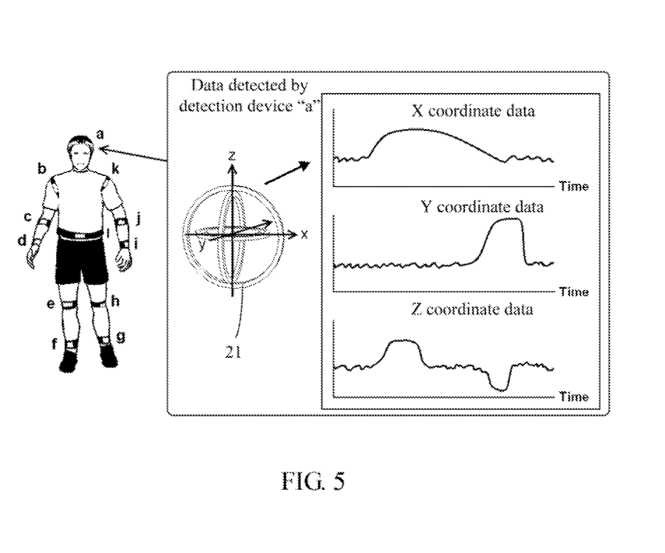

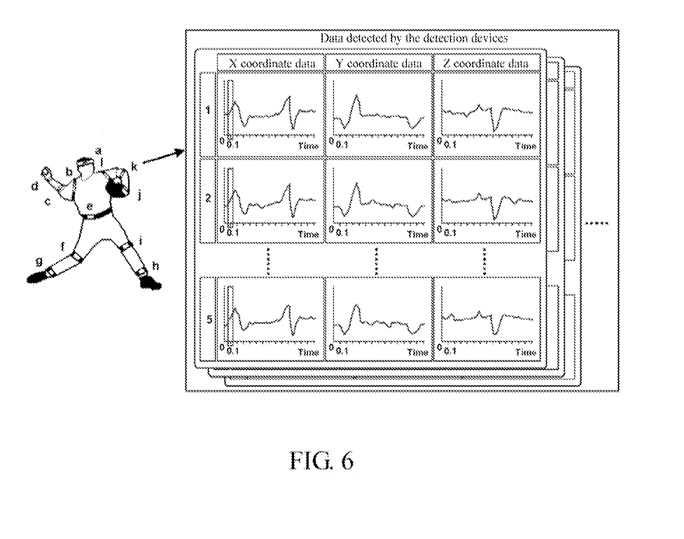

As the user is demonstrating each action sample 200 (i.e., a correct action sample 210 or a wrong action sample 220), each detection device 2 worn on a body part (such as the head) of the user detects movement data, such as X, Y, Z coordinate data of the body part by the E-gyroscope 21, and transmits the movement data in relation to the action sample 200 to the computing device 1 by the network module 22 (as shown in FIG. 4). For example, FIG. 5 illustrates X, Y, Z coordinate data in relation to the head of the user when the user is demonstrating an action sample. FIG. 6 illustrates X, Y, Z coordinate data in relation to different body parts of the user, which are detected by the detection devices 20 worn on the different body parts of the user.

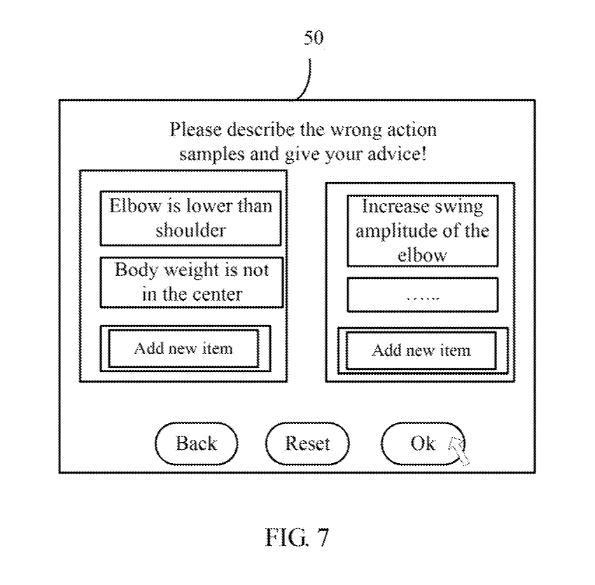

Because the action sample 200 demonstrated by the user may be a correct action sample 210 or a wrong action sample 220, the user should select a type for the movement data in relation to each action sample 200. As shown in FIG. 4, the user determines whether the movement data is stored as data in relation to a correct action sample 210 or stored as a wrong action sample 220. If the movement data is stored as data in relation to a wrong action sample 220, the system 10 prompts a dialog to request the user to describe the wrong action sample 220 and give advice to correct the wrong action sample 220. For example, as shown in FIG. 7, the left column allows the user to add a concise description of each wrong action sample 220, and the right column allows the user to add a suggestion for correcting each wrong action sample 220. For example, a wrong action sample 220 is described as “Elbow is lower than shoulder,” and a suggestion to correct the wrong action sample 220 is “Increase swing amplitude of the elbow,” as shown in FIG. 7.

In one embodiment, each correct action sample 210 includes X, Y, Z coordinate data in relation to one or more body parts of the user at different sample times. As the user is demonstrating a correct action sample 210, at each sample time, the detection device 2 worn on each body part of the user detects the X, Y, Z coordinate data of the body parts. For example, if the correct action sample 210 lasts 1.5 seconds, and fifteen sample times are defined, such as a first sample time is 0.1 seconds, a second sample time will be 0.2 seconds, and so on. If the user demonstrates the correct action sample 210 five times, then the X coordinate data in relation to the head of the user at each sample time “0.1 seconds” of the five times may include “124 cm, 162 cm, 165 cm, 155 cm, 158 cm.” In one embodiment, the X, Y, Z coordinate data of each body part obtained at each sample time may form a value range for movement of the body part. For example, X coordinate values “124 cm, 162 cm, 165 cm, 155 cm, 158 cm” are obtained for the sample time “0.1 seconds” and may form a value range of [124, 165], or a value range of [155, 165], where the value 124 which has the greatest divergence from any other value is not taken into consideration.

As mentioned above, the standard for determining whether actions of players are correct when playing the video game may be the degree of similarity between each action of a player and a correct action sample 210 being equal to or more than the predetermined value (e.g., 80%). In one embodiment, when the similarity degree is set as 80%, each action/correct action sample 210 has fifteen sample times, and at each sample time of the correct action sample 210, a value range for X coordinate data is determined, a value range for Y coordinate data is determined, and a value range for Z coordinate data is determined. Fifteen sample times×80%=twelve sample times. Then, in one embodiment, the action of the player may be determined as correct on condition that twelve sample times of the action can be found, where for each of the twelve sample times, the X, Y, Z coordinate data respectively falls within a value range derived from the corresponding correct action sample 210.

In another embodiment, the action of the player may be determined as correct on condition that, for each sample time, at least 80% X, Y, Z coordinate values in relation to the action fall within a corresponding value range. For example, if at each sample time a number N1 of X coordinate values are obtained, a number N2 of Y coordinate values are obtained, and a number N3 of Z coordinate values are obtained, then when there is “N1×80%” X coordinate values falling within a corresponding X value range, “N2×80%” Y coordinate values falling within a corresponding Y value range, and “N3×80%” Z coordinate values falling within a corresponding Z value range, the action is determined as correct.

In step S20, when a player starts the video game stored in the computing device 1, the action sample creation module 11 in sequence displays the correct action samples 210 of the video game on the screen 50. For example, after the player selects the option “Start action direction” shown in FIG. 3A, the action sample creation module 11 begins to display the correct action samples 210 one by one on the screen 50, and the player may begin to perform actions to play the video game.

In step S30, each detection device 2 worn on a body part (such as the head) of the player detects movement data, such as X, Y, Z coordinate data of the body part by the E-gyroscope 21 as the player performs each action, and transmits the movement data in relation to the action sample 200 to the computing device 1 by the network module 22. The data receiving module 12 receives the movement data in relation to the body parts of the player which are detected by the detection devices 2 when the player is playing each action, and stores the movement data into the storage device 20.

In step S40, the data comparison module 13 compares the movement data in relation to each action performed by the player with a corresponding correct action sample 210 stored in the storage device. For example, if the movement data in relation to a first action of the player includes X, Y, Z coordinate data of each body part obtained at fifteen sample times by the detection devices 2, the data comparison module 13 compares the X, Y, Z coordinate data of each body part obtained at each sample time with the X, Y, Z coordinate data in relation to a same sample time of a first correct action sample 210.

In step S50, the data comparison module 13 determines whether the action by performed the player is correct according to a comparison result and the standard. If the action performed the player is determined as correct, the action sample creation module 11 displays a next correct action sample 210, and the procedure ends. For example, when the standard is defined as the similarity degree (e.g., 80%) between each action of the player and a corresponding correct action sample 210, each action/correct action sample 210 has fifteen sample times, when for each of 12 sample times of the first action, X, Y, Z coordinate data respectively fall within a corresponding value range determined from the correct action sample 210. The first action is thus determined as correct, the action sample creation module 11 displays a second correct action sample 210, and the procedure ends.

Otherwise, in step S50, if the action performed by the player is determined as wrong, in step S60, the data comparison module 13 compares the movement data in relation to the action performed by the player with one or more wrong action samples 220 stored in the storage device, to determine which wrong action sample 220 that the action belongs to. The comparison is similar to the comparison in step S40 described above. Furthermore, the prompt module 14 displays one or more suggestions for correcting the action on the screen 50, so that the player can correct his/her action according to the one or more suggestions.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device, the method comprising:
setting correct action samples and wrong action samples for a video game stored in the computing device and a standard for determining whether actions of players are correct when the video game is played;
in sequence, displaying the correct action samples on a screen when a player starts the video game;
receiving movement data of the player in relation to each action of the player;
comparing the movement data in relation to each action of the player with movement data of a corresponding correct action sample, and determining whether the action performed by the player is correct according to a comparison result of the comparison and the standard; and
displaying a next correct action sample on the screen in response to determining the action is correct, and determining which wrong action sample the action belongs to and displaying suggestions to correct the action on the screen in response to determining the action is wrong.

2. The method as claimed in claim 1, wherein the standard is a degree of similarity between each action of the player and a corresponding correct action sample, and the similarity degree is equal to or more than a predetermined value.

3. The method as claimed in claim 1, wherein the movement data in relation to each action of the player comprise X, Y, Z coordinate data of body parts of the player, and the X, Y, Z coordinate data of each body part of the player is detected by a detection device worn on the body part of the player.

4. The method as claimed in claim 3, wherein the movement data in relation to each action of the player and the movement data of the corresponding correct action sample are obtained at predetermined sample times.

5. The method as claimed in claim 4, wherein the X, Y, Z coordinate data of each body part of the player obtained at each sample time is compared with X, Y, Z coordinate data of the same body part contained by the corresponding correct action sample at the same sample time.

6. A non-transitory computer-readable medium having stored thereon instructions that, when executed by a processor of a computing device, cause the processor to perform operations of:
setting correct action samples and wrong action samples for a video game stored in the computing device and a standard for determining whether actions of players are correct when the video game is played;
in sequence, displaying the correct action samples on a screen when a player starts the video game;
receiving movement data of the player in relation to each action of the player;
comparing the movement data in relation to each action of the player with movement data of a corresponding correct action sample, and determining whether the action performed by the player is correct according to a comparison result of the comparison and the standard; and
displaying a next correct action sample on the screen in response to determining the action is correct, and determining which wrong action sample the action belongs to and displaying suggestions to correct the action on the screen in response to determining the action is wrong.

7. The medium as claimed in claim 6, wherein the standard is a degree of similarity between each action of the player and a corresponding correct action sample, and the similarity degree is equal to or more than a predetermined value.

8. The medium as claimed in claim 6, wherein the movement data in relation to each action of the player comprise X, Y, Z coordinate data of body parts of the player, and the X, Y, Z coordinate data of each body part of the player is detected by a detection device worn on the body part of the player.

9. The medium as claimed in claim 8, wherein the movement data in relation to each action of the player and the movement data of the corresponding correct action sample are obtained at predetermined sample times.

10. The medium as claimed in claim 9, wherein the X, Y, Z coordinate data of each body part of the player obtained at each sample time is compared with X, Y, Z coordinate data of the same body part contained by the corresponding correct action sample at the same sample time.

11. A computing device comprising:
a processor; and
a storage device that stores one or more programs that, when executed by the processor, causing the processor to perform operations of:
setting correct action samples and wrong action samples for a video game stored in the computing device and a standard for determining whether actions of players are correct when the video game is played;
in sequence, displaying the correct action samples on a screen when a player starts the video game stored in the computing device;
receiving movement data of the player in relation to each action of the player;
comparing the movement data in relation to each action of the player with movement data of a corresponding correct action sample, and determining whether the action performed by the player is correct according to a comparison result of the comparison and the standard; and
displaying a next correct action sample on the screen in response to determining the action is correct, and determining which wrong action sample the action belongs to and displaying suggestions to correct the action on the screen in response to determining the action is wrong.

12. The computing device as claimed in claim 11, wherein the standard is a degree of similarity between each action of the player and a corresponding correct action sample, and the similarity degree is equal to or more than a predetermined value.

13. The computing device as claimed in claim 11, wherein the movement data in relation to each action of the player comprise X, Y, Z coordinate data of body parts of the player, and the X, Y, Z coordinate data of each body part of the player is detected by a detection device worn on the body part of the player.

14. The computing device as claimed in claim 13, wherein the movement data in relation to each action of the player and the movement data of the corresponding correct action sample are obtained at predetermined sample times.

15. The computing device as claimed in claim 14, wherein the X, Y, Z coordinate data of each body part of the player obtained at each sample time is compared with X, Y, Z coordinate data of the same body part contained by the corresponding correct action sample at the same sample time.
